(19) United States
(12) Patent Application Publication
(10) Pub. No.: US 2008/0169443 A1
(43) Pub. Date: Jul. 17, 2008

(54) Ball valve

(76) Inventor: Donald Loloff, Kersey, CO (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 12/009,179

(22) Filed: Jan. 17, 2008

Related U.S. Application Data
(60) Provisional application No. 60/881,045, filed on Jan. 17, 2007.

(51) Int. Cl. F16K 5/08

(52) U.S. Cl. 251/315.1; 251/315.16

(57) ABSTRACT

A ball valve employing a flush inlet in the ball and a flush exhaust port in the valve body for communication with the ball valve port when the ball is oriented to allow source fluid to enter the ball valve port through the flush inlet is disclosed. The ball valve allows for convenient back flushing of an optional filter or located in the ball valve port and subsequent expulsion of debris flushed from the optional filter from the valve body through the flush exhaust port. The disclosed ball valve also allows for a simple method of collected fluid samples when a sample collector is connected to the flush exhaust port. The disclosed valve also operates to completely arrest fluid flow from the first end of the valve body to the second end in a manner similar to valve known in the prior art.

### CROSS REFERENCE TO RELATED APPLICATIONS

Applicant, Donald Loloff, a U.S. citizen, claims priority under 35 U.S.C. § 119(e) of provisional U.S. Patent Application Ser. No. 60,881,045 filed on Jan. 17, 2007 entitled “Ball Valve”, which is incorporated by reference herein.

### FIELD OF THE INVENTION

The present invention relates to a ball valve design in which the ball of the valve incorporates a flush port drilled through one side of the ball perpendicular to the fluid flow direction, and wherein the valve body incorporates a flush exhaust port for communication with the flush port when the valve is in the flush position. The combination of the flush port in the valve ball and the flush exhaust port in the valve body allow for back-flushing of an optional filter in the ball and subsequent expulsion through the flush exhaust port of any debris that have accumulated on the filter.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### DETAILED DESCRIPTION

### Brief Description of the Drawings

FIG. 1 illustrates one example of a full port ball valve of the prior art.

FIG. 2 illustrates one example of a standard port ball of the prior art.

FIG. 3A shows the disclosed Ball Valve in position A as viewed from the first end.

FIG. 3B shows the disclosed Ball Valve in position A as viewed from the side with the flush exhaust port.

FIG. 3C shows the disclosed Ball Valve in position A as viewed from the second end.

FIG. 3D provides a cross-sectional view of the Ball Valve in position A along the longitudinal axis of a fluid conduit connected to the Ball Valve.

FIG. 4A shows the disclosed Ball Valve in position B as viewed from the first end.

FIG. 4B shows the disclosed Ball Valve in position B as viewed from the side with the flush exhaust port.

FIG. 4C shows the disclosed Ball Valve in position B as viewed from the second end.

FIG. 4D provides a cross-sectional view of the Ball Valve in position B along the longitudinal axis of a fluid conduit connected to the Ball Valve.

FIG. 4E shows the disclosed Ball Valve in position B as viewed from the side without the flush exhaust port.

FIG. 5A shows the disclosed Ball Valve in position C as viewed from the first end.

FIG. 5B shows the disclosed Ball Valve in position C as viewed from the side with the flush exhaust port.

FIG. 5C shows the disclosed Ball Valve in position C as viewed from the second end.

FIG. 5D provides a cross-sectional view of the Ball Valve in position C along the longitudinal axis of a fluid conduit connected to the Ball Valve.

FIG. 5E shows the disclosed Ball Valve in position C as viewed from the side without the flush exhaust port.

### DETAILED DESCRIPTION

### Element Listing

| Element Description | Element Number |
|---|---|
| Diameter of Port in Full Port Ball Valve | 1 |
| Diameter of Fluid Conduit | 2 |
| Intentionally Left Blank | 3 |
| Diameter of Port in Standard Port Ball | 4 |
| Valve | |
| Flush Inlet | 5 |
| Intentionally Left Blank | 6 |
| Ball | 7 |
| Ball Valve | 8 |
| First End | 9 |
| Valve Body | 10 |
| Second End | 11 |
| Flush Exhaust Port | 12 |
| Filter | 13 |
| Valve Handle | 14 |
| Ball Valve Port | 15 |
| Fluid Conduit | 16 |

### DETAILED DESCRIPTION

Typically, the port 15 in a ball valve 8 comes in three configurations: full port, standard port, and reduced port. In a full port configuration, the cross-sectional area of the ball valve port 15 is equal in shape and size to the cross-sectional area of the fluid conduit 16. In a standard port configuration, the cross-sectional area of the ball valve port 15 is smaller than the cross-sectional area of the fluid conduit 16 and not necessarily the same shape as that of the fluid conduit 16. In a reduced port configuration, the cross-sectional area of the ball valve port 15 is typically two pipe sizes smaller than the cross-sectional area of the fluid conduit 16, but not necessarily the same shape.

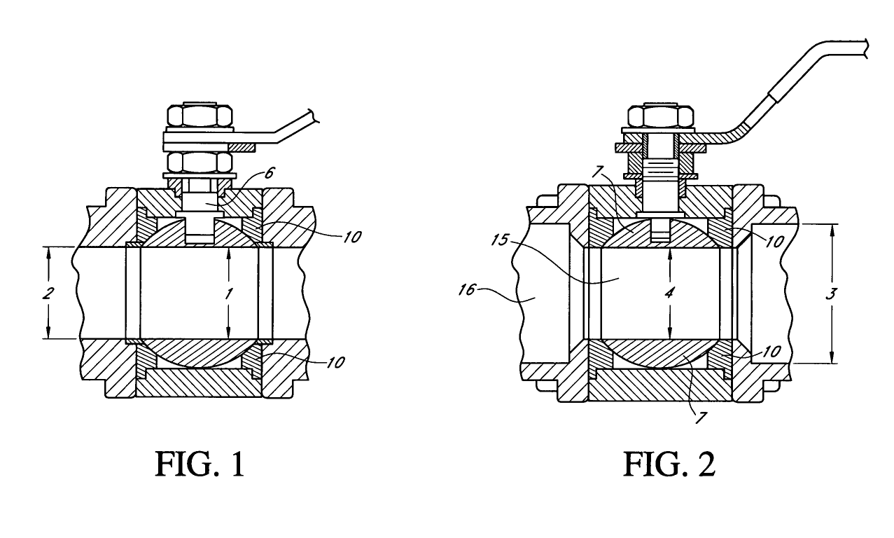

FIG. 1 illustrates a conventional full port ball valve as found in the prior art. The diameter of the port in the full port ball valve 1 is equal to the diameter of the fluid conduit 2 adjacent the valve. Also, both the shape of the ball valve port 15 and the shape of the fluid conduit 16 are circular. The equal diameters yield equal cross-sectional areas for the fluid conduit 16 and the ball valve port 15 according to the geometric relation for a circle,

$$CA = {( \frac{Diameter}{2} )}^{2} \times π ,$$

where CA is the cross sectional area of the circle.

FIG. 2 illustrates a conventional standard port ball valve as found in the prior art. The diameter of the port in a standard port ball valve 4 is smaller than the diameter of the fluid conduit 2 adjacent the valve. In FIG. 2, the ball valve port 15 and the fluid conduit 16 appear as though the shape of both is circular, though not all standard port ball valves employ a circular shaped port.

Conventional reduced port ball valves as found in the prior art (not shown) are similar to conventional standard port ball valves. A cut-away diagram for a conventional reduced port ball valve would appear similar to FIG. 2, but the difference between the diameter of the ball valve port 4 and the diameter of the fluid conduit 2 would be more exaggerated than the difference between the two dimensions in FIG. 2.

Often, ball valves are designed with fluid flow characteristics being of paramount importance. Pressure drop across the valve, volumetric flow rate through the valve at a given fluid pressure, and fluid turbulence generated by fluid passage through the valve are often optimized so that fluid flow through the open valve mimics as closely as possible fluid flow through the fluid conduit 16. Occasionally, ball valves are designed so that the ball valve port 15 changes the fluid flow characteristics in some predetermined manner, such as lowering fluid pressure or volumetric flow rate at a specified fluid pressure.

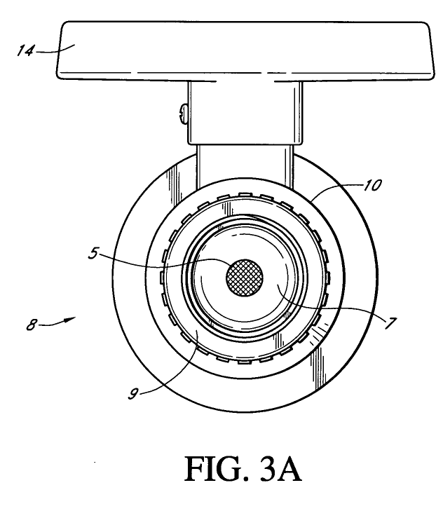

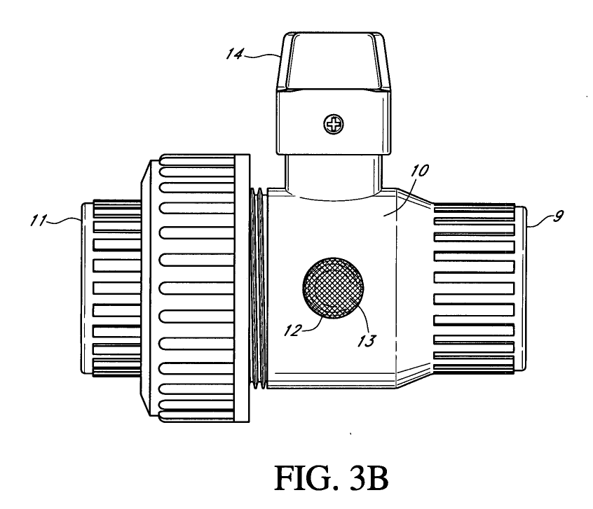

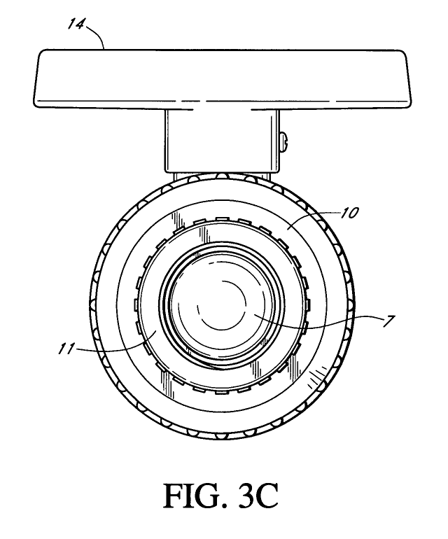

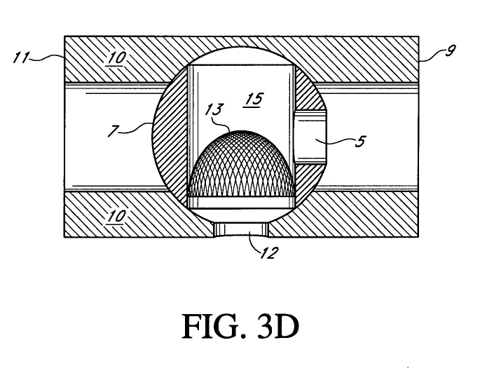

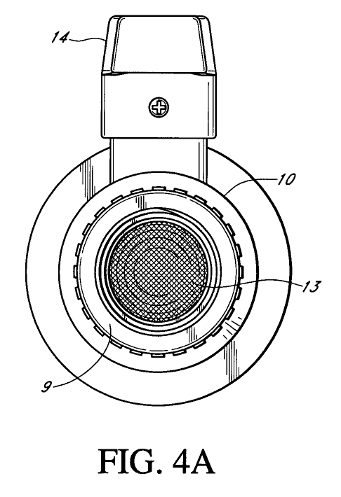

The disclosed ball valve 8 provides for a simple means with which to back-flush the ball valve 8. The ball 7 is outfitted with a flush inlet 5. The flush inlet 5 is oriented perpendicular to the fluid flow through the ball valve 8 (i.e., perpendicular to the longitudinal axis of the ball valve port 15), and is in direct communication with the ball valve port 15 in the ball 7 (as is best shown in FIGS. 3D, 4D, and 5D). This design allows for fluid flow from the flush inlet 5 into the ball valve port 15 and vice versa. Only one side of the ball 7 is fashioned with a flush inlet 5 so that the ball valve 8 is still capable of completely arresting fluid flow between the first end 9 and the second end 11 of the valve body 10. In the embodiments disclosed and pictured herein, the diameter of the flush inlet 5 and of the flush exhaust port 12 are both less than the diameter of the ball valve port 15; however, the respective diameters are not limited to the embodiments pictured herein and may be determined by the particular application of the disclosed ball valve 8. For example, the diameter of the flush exhaust port 12 may be greater than the diameter of the ball valve port 15, as may the diameter of the flush inlet 5. Furthermore, although circular in the embodiments pictured herein, the cross-sectional shape of the flush inlet 5, ball valve port 15, and flush exhaust port 12 may be of any convenient cross-sectional shape for the particular application.

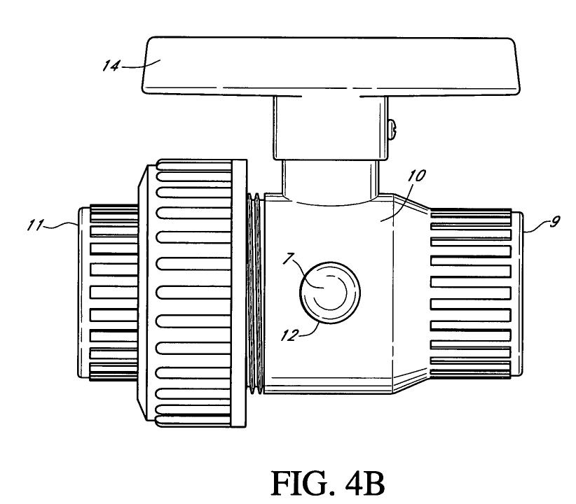

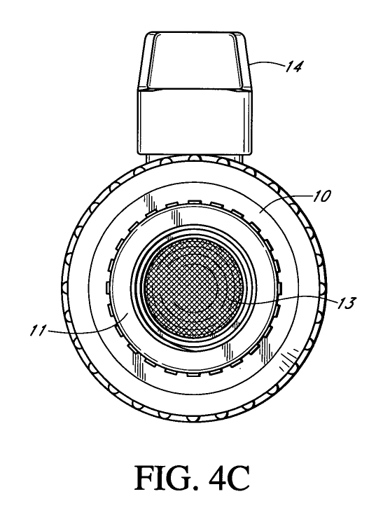

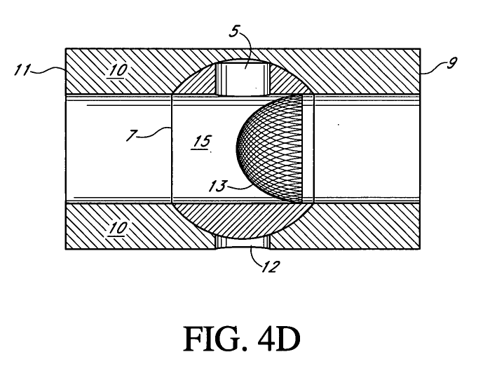

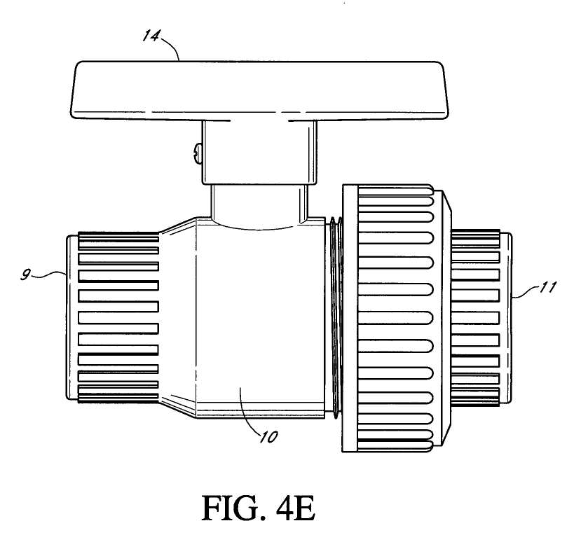

FIG. 3A shows the flush inlet 5 viewed from the first end 9 with the ball valve 8 in position A. Rather than fully arresting fluid flow within the valve body 10, as a ball valve from the prior art would do in this position, in position A the disclosed ball valve 8 directs fluid from the first end 9 into the flush inlet 5, through the ball valve port 15, and out the flush exhaust port 12 in the valve body 8, which is best shown in FIGS. 3B and 3D. A filter 13 may be placed within the ball valve port 15 in any embodiment of the disclosed ball valve. As shown in the embodiments pictured herein, the filter 13 is conical in shape positioned towards the first end 9 when the ball valve 8 is in position B (described in detail below and best shown in FIG. 4D). Such placement and shape of the filter 13 (optional) as shown in the embodiments pictured herein is contemplated when the first end 9 is fashioned as the fluid inlet and the second end 11 is fashioned as the fluid outlet during normal fluid flow. However, the shape, material, and/or precise location of the filter 13 in no way limit the scope of the present invention, and such specifications are limited only by the particular application for which the ball valve 8 is used. For example, the filter 13 (optional) may be made of a wire-screen mesh, a cellulosic-fiber material, or any other material known to those skilled in the art that is suitable for the application. Furthermore, in an embodiment not shown herein the filter 13 (optional) may be shaped substantially as a disk so that the filter 13 (optional) has the same cross-sectional area as the ball valve port 15. Additionally, in an embodiment not shown herein the filter 13 (optional) may be configured as a replacement cartridge allowing removal and disposal or maintenance.

A fluid conduit, such as piping, may be affixed to the flush exhaust port 12 and routed to a desired location, or the flush exhaust port 12 may simply remain open, as in the embodiments pictured herein. In position A, the ball valve port 15 is in communication with the flush exhaust port 12 to allow for fluid flow from the ball 7 out the flush exhaust port 12. FIG. 3C shows the ball valve 8 in position A from the second end 11, from which it is apparent that the ball 7 completely prevents fluid flow from the first end 9 to the second end 11 and from the second end 11 to the first end 9 when in position A. This is because when in position A, the ball valve port 15 is not in fluid communication with the second end 11.

By rotating the valve handle 14 ninety degrees counterclockwise, the ball valve 8 is moved from position A to position B. FIG. 4A shows the ball valve 8 viewed from the first end 9 in position B. In position B the flush inlet 5 is adjacent the side of the valve body 10 without the flush exhaust port 12, which is best seen in FIG. 4D (and which may be seen externally in FIG. 4E). The side of the ball 7 without the flush inlet 5 is adjacent the side of the valve body 10 with the flush exhaust port 12, as shown in FIGS. 4B and 4D, so that no fluid may exit the valve body 10 except through either the first end 9 or the second end 11. As can be seen in FIGS. 4A, 4C, and 4D, in position B, fluid flows through the valve body 10 from either the first end 9 to the second end 11 through the filter 13 (optional) in the ball valve port 15, or from the second end 11 to the first end 9 through the filter 13 (optional) in the ball valve port 15, depending on whether the first end 9 or the second end 11 is oriented to provide the fluid inlet into the valve body 10.

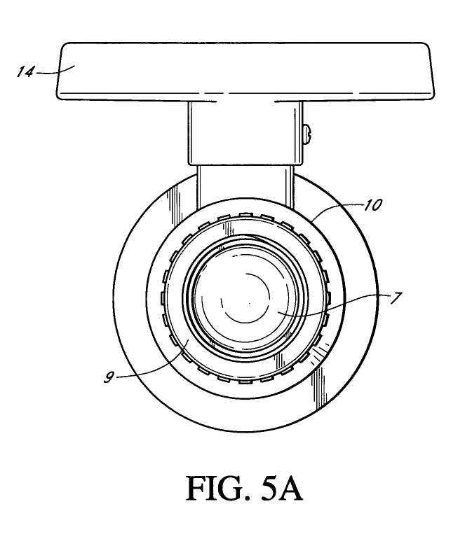

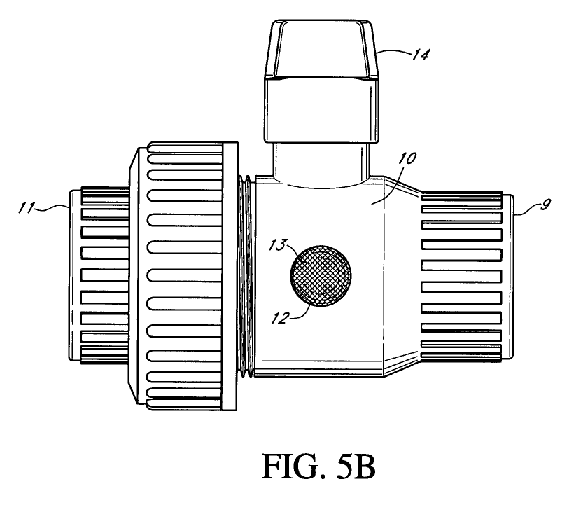

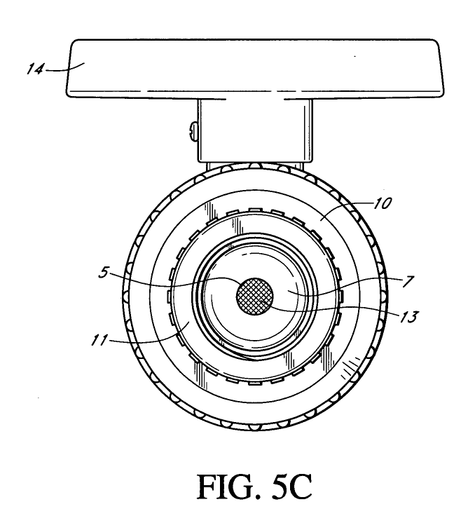

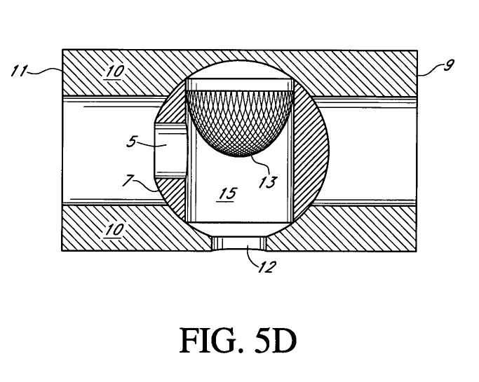

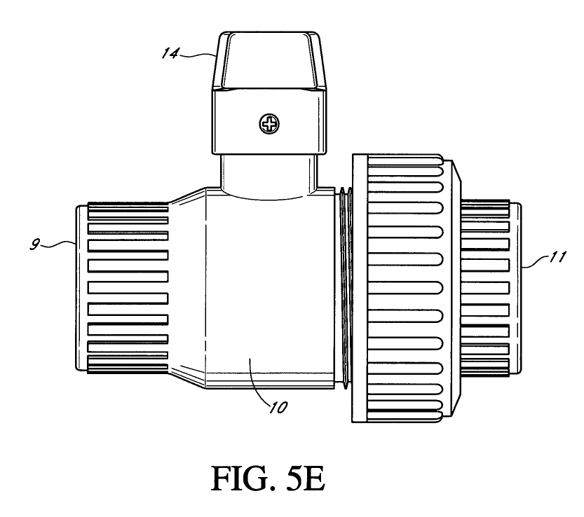

By rotating the valve handle 14 ninety degrees counterclockwise from position B, the ball valve 8 is placed in position C, which correlates to position A in some aspects. FIG. 5A shows the ball valve 8 from the first end 9 in position C. In position C, the ball 7 completely prevents fluid flow from the first end 9 to the second end 11 and from the second end 11 to the first end 9, as is best shown in FIG. 5D. FIG. 5B shows the ball valve 8 from the side of the valve body 10 with the flush exhaust port 12, which communicates with the ball valve port 15 in this position. FIG. 5C shows the ball valve 8 from the second end 11 in position C where the flush inlet 5 is visible. In position C, rather than completely arresting fluid flow within the valve body 10, as a ball valve from the prior art would in this position, the disclosed ball valve 8 directs fluid from the second end 11 into the flush inlet 5 and out of the valve body through the exhaust flush port 12, which is best shown in FIGS. 5B, 5C, and 5D. The side of the valve body 10 without the fluid exhaust port 12 is shown in FIG. 5D with the ball valve 8 in position C.

The difference between position A (shown in FIGS. 3A-3D) and position C (shown in FIGS. 5A-5E) hinges on whether the first end 9 or the second end 11 is connected to the source fluid and the position of the optional filter 13. It is contemplated that the embodiments pictured herein are most likely to be used in a system wherein the fluid inlet is connected to the first end 9 and the fluid outlet is connected to the second end 11. If the first end 9 is connected to the source fluid and thereby provides the inlet of the source fluid into the valve body 10, then the fluid will flow from the first end 9 through the filter 13 (optional) in the ball valve port 15 to the second end 11 when the ball valve is in position B, which correlates to a fully open position.

Position A provides for a back-flush of the filter 13 (optional) in the ball valve port 15 in the embodiment pictured herein. When the embodiment pictured is in position A (best shown in FIG. 3D) the source fluid will enter the valve body 10 from the first end 9, flow through the flush inlet 5 into the ball valve port 15, through the filter 13 (optional) in the direction opposite of the fluid flow through the filter 13 (optional) when in position B, and exit the valve body 10 along with any debris collected on and subsequently flushed from the filter 13 (optional) through the flush exhaust port 12. That is, when the ball valve 8 is in position A, the fluid will travel through the filter 13 (optional) in the ball valve port 15 in a direction substantially opposite to the direction that the fluid travels through the filter 13 (optional) when the ball valve 8 is in position B, thereby creating a back-flush of the filter 13 (optional) for removal of debris collected in the filter 13 (optional) when the ball valve 8 is open in position B.

Position C closes off the fluid source from the valve body 8 by blocking fluid entry into the first end 9 and thereby closes the ball valve 8 so that fluid cannot travel from the first end 9 to the second end 11, which correlates to a closed position. As is known to those skilled in the art, the disclosed ball valve is a bi-directional valve that can achieve the same objective whether the first end 9 or the second end 11 is connected to the fluid inlet, in which position A and position C would perform the opposite functions, depending on the location of the optional filter 13, which is best seen in a comparison of FIGS. 3D and 5D.

The disclosed ball valve 8 may be manually operated or it may be automated via an electric actuator, a pneumatic actuator, or other means known to those skilled in the art (not shown). The disclosed ball valve 8 may also be integrated into a program logic controller (PLC) that may be programmed to actuate the ball valve 8 at certain time intervals or if certain predetermined conditions are met, such as a set pressure differential or a set volumetric flow-rate. The PLC may be integrated with a database to tabulate the actuation of the ball valve 8 to determine the optimal number of filter 13 (optional) flushes for a set of conditions. The information from the ball valve 8 or the ball valve's limit switches (not shown) may be relayed to the system operator or the associated computer system, as is well known to those skilled in the art, by transmission means such as electrical conduit, wireless transmitters using radio frequencies (which may be Bluetooth enabled), microwave frequencies, or other transmission means that are known to those skilled in the art.

The preceding elements may also be used to facilitate an automated sampling system. In such a system, a filter 13 would most likely not be placed within the ball valve port 13 and a fluid conduit would likely be connected to the flush exhaust port 12 and routed to a desired sample collection location (not shown). The system could be automated through a PLC so that the ball valve 8 is set to actuate at certain times for a predetermined length, thereby facilitating a sample at a particular time of a particular volume. In another configuration, not shown herein, the actuation of the ball valve 8 by the PLC may be connected to a sensor (not shown) internal or external to the piping system which the ball valve is a part of and wherein a pre-determined condition such as temperature, concentration of ingredients, and or presence of a system contaminant such as E. coli in a food processing stream or benzene in a water stream would result in actuation of ball valve 8 by the PLC to either capture a sample of the material in the piping system or allow for removal of a contaminant from the piping system.

The ball valve port 15 in the embodiments pictured herein is contemplated to be a full port configuration. However, other configurations (such as standard port or reduced port) may be used in other embodiments without departing from the spirit and scope of the present invention.

It should be noted that the present invention is not limited to the specific embodiments pictured and described herein, but is intended to apply to all similar apparatuses providing for a three-way ball valve. Accordingly, modifications and alterations from the described embodiments will occur to those skilled in the art without departure from the spirit and scope of the present invention.

1. A ball valve comprising:
a. a valve body;
b. a ball, wherein said ball seats within said valve body, wherein said ball is fashioned with a ball valve port extending through said ball, and wherein said ball is fashioned with a flush inlet substantially perpendicular to said ball valve port; and,
c. a flush exhaust port, wherein said flush exhaust port extends through and is located on one side of said valve body.

2. The ball valve according to claim 1, wherein said ball further comprises a filter across said ball valve port.

3. The ball valve according to claim 1, wherein said ball valve port is further defined as having a circular cross-sectional shape.

4. The ball valve according to claim 1, wherein said flush inlet is further defined as having a circular cross-sectional shape.

5. The ball valve according to claim 1, wherein said flush exhaust port is further defined as having a circular cross-sectional shape.

6. The ball valve according to claim 1, wherein said ball valve port has the same cross-sectional area as a fluid conduit connected to said valve body.

7. The ball valve according to claim 1, wherein said ball valve port has a smaller cross-sectional area compared to a fluid conduit connected to said valve body.

8. The ball valve according to claim 1, wherein a fluid conduit is connected to said flush exhaust port.

9. The ball valve according to claim 1, wherein the cross-sectional area of said flush exhaust port is greater than the cross-sectional area of said flush inlet.

10. The ball valve according to claim 1, wherein the cross-sectional area of said flush exhaust port is greater than the cross-sectional area of said ball valve port.

11. The ball valve according to claim 1, wherein the position of said ball valve is manipulated via an automated actuator.

12. The ball valve according to claim 11, wherein said automated actuator is controlled via a PLC to change the position of said ball valve according to a predetermined condition.

13. The ball valve according to claim 12, wherein said ball valve is connected to a piping system circulating a fluid.

14. The ball valve according to claim 13, wherein said predetermined condition is determined is by the condition of the piping system, a property of the fluid circulated within said piping system or a combination of both.

15. The ball valve according to claim 12 wherein said predetermined condition is further defined as a pressure drop across said ball valve.

16. The ball valve according to claim 12 wherein said predetermined condition is further defined as a specific volumetric-flow rate at one end of said valve body.

17. The ball valve according to claim 11, wherein said flush exhaust port is connected to a fluid conduit.

18. A ball valve comprising:
a. a valve body;
b. a ball, wherein said ball seats within said valve body, wherein said ball is fashioned with a ball valve port extending through said ball, and wherein said ball is fashioned with a flush inlet substantially perpendicular to said ball valve port;
c. a filter, wherein said filter is placed within said ball valve port; and,
d. a flush exhaust port, wherein said flush exhaust port extends through and is located on one side of said valve body.
